(19) United States
(12) Patent Application Publication
(10) Pub. No.: US 2015/0142656 A1
(43) Pub. Date: May 21, 2015

(54) SYSTEMS AND METHODS FOR INTEGRATING AN ENVIRONMENTAL IMPACT OFFSET WITH A PAYMENT CARD USAGE PROGRAM

(71) Applicant: MasterCard International Incorporated, Purchase, NY (US)

(72) Inventor: Jason J. Lacoss-Arnold, St. Louis, MO (US)

(73) Assignee: MasterCard International Incorporated, Purchase, NY (US)

(21) Appl. No.: 14/086,509

(22) Filed: Nov. 21, 2013

(51) Int. Cl. G06Q 30/02; G06Q 20/12

(52) U.S. Cl. CPC G06Q 30/0279; G06Q 20/12
USPC 705/44

(57) ABSTRACT

A computer-implemented method for generating environmental impact offsets for payment card transactions is described. The method implemented using a computing device in communication with a memory. The method includes storing, in the memory, a plurality of offset factors associated with a plurality of merchants, receiving a first authorization request message for a payment transaction originating from an originating merchant for a cardholder that includes a transaction amount, determining the offset factor associated with the originating merchant, calculating, by the computing device, an offset amount based on the transaction amount and the offset factor, outputting the offset amount.

### BACKGROUND OF THE DISCLOSURE

The field of the disclosure relates generally to calculating environmental impact offsets, and more particularly to generating an environmental impact offset for a purchase made by a cardholder using a payment card.

When goods are produced or services are provided to a consumer there is typically an impact on the environment (e.g., an amount of carbon is emitted into the atmosphere, energy is consumed, etc.). For example, when a consumer purchases an airline ticket, as least a portion of the carbon gases emitted from the flight of that airplane can be attributed to the purchase of that ticket. In the case of some industries, environmental impact lists exist, which attempt to quantify an amount of impact a particular business type may have on the environment. For example, a business type, such as a restaurant, may be included on one of these lists based on how much carbon a typical or average restaurant would emit. In some cases, a particular restaurant chain may indicate how much carbon a typical restaurant location may emit in operating such a restaurant location.

### BRIEF DESCRIPTION OF THE DISCLOSURE

In one aspect, a computer-implemented method for generating environmental impact offsets for payment card transactions is described. The method is implemented using a computing device in communication with a memory. The method includes storing in the memory a plurality of offset factors associated with a plurality of merchants, receiving a first authorization request message for a payment transaction originating from an originating merchant for a cardholder that includes a transaction amount, determining the offset factor associated with the originating merchant, calculating by the computing device an offset amount based on the transaction amount and the offset factor, and outputting the offset amount.

In another aspect, a computing device for generating environmental impact offsets for payment card transactions is described. The computing device includes a processor communicatively coupled to a memory device. The computing device is configured to store a plurality of offset factors associated with a plurality of merchants, receive a first authorization request message for a payment transaction originating from an originating merchant for a cardholder that includes a transaction amount, determine the offset factor associated with the originating merchant, calculate an offset amount based on the transaction amount and the offset factor, and output the offset amount.

In yet another aspect, a computer-readable storage medium having computer-executable instructions embodied thereon is described. When executed by a computing device having at least one processor coupled to a memory device, the computer executable instructions cause the processor to store a plurality of offset factors associated with a plurality of merchants, receive a first authorization request message for a payment transaction originating from an originating merchant for a cardholder that includes a transaction amount, determine the offset factor associated with the originating merchant, calculate an offset amount based on the transaction amount and the offset factor, and output the offset amount.

### BRIEF DESCRIPTION OF THE DRAWINGS

FIGS. 1-7 show example embodiments of the methods and systems described herein.

FIG. 1 is a schematic diagram illustrating an example multi-party payment card industry system for enabling ordinary payment-by-card transactions in which merchants and card issuer processors do not necessarily have a one-to-one relationship.

FIG. 2 is a simplified block diagram of an example environmental impact system configured to generate environmental impact offsets for cardholder purchases in accordance with one embodiment of the present disclosure.

FIG. 3 illustrates an example configuration of a client system shown in FIG. 2, in accordance with one embodiment of the present disclosure.

FIG. 4 illustrates an example configuration of the server system shown in FIG. 2, in accordance with one embodiment of the present disclosure.

FIG. 5 is a schematic diagram which illustrates an example of integrating a multi-party payment card system with generating environmental impact offsets for cardholder purchases.

FIG. 6 is a flowchart illustrating an example of the process of generating environmental impact offsets for cardholder purchases, in accordance with one embodiment of the present disclosure.

FIG. 7 is a diagram of components of one or more example computing devices that may be used in the environmental impact system shown in FIG. 2.

### DETAILED DESCRIPTION OF THE DISCLOSURE

The following detailed description illustrates embodiments of the disclosure by way of example and not by way of limitation. It is contemplated that the disclosure has general application to calculating environmental impact offsets.

The systems and methods described herein relate to calculating environmental impact offsets. More specifically, the systems and methods described herein include generating an environmental impact offset for a purchase made by a cardholder using a payment card.

Purchases made by a consumer may have an impact on the environment. For example, a consumer that purchases an airline ticket may impact the environment through the carbon emissions emitted by the airplane to transport the consumer. Similarly, a consumer that purchases a meal at a restaurant may have caused an impact on the environment through the carbon emissions of the restaurant in preparing the meal, through the farmer's actions in raising the ingredients, through the distribution of the materials to the restaurant, or through other impacts on the environment. In many cases, these emissions or impacts can be quantified for each merchant that provides a product or service. Further, the emissions or impacts can be quantified for each individual consumer. For example, for each passenger on one round trip flight from New York City to Los Angeles the airline may release 0.7 metric tons of carbon dioxide into the atmosphere.

The systems and methods described herein are configured to address and/or offset the environmental impact of such purchases made by consumers. For example, in an effort to counteract a consumer's impact on the environment from his or her purchases, the consumer may decide to purchase environmental offsets using the systems described herein. These environment impact offsets may include donations made to an environmental charity, where the environmental charity supports projects that remove carbon from the atmosphere or reduce future emissions of carbon or other greenhouse gases. In the New York to Los Angeles example, to counteract the 0.7 metric tons that have been released by the roundtrip flight, the consumer may donate a percentage of the purchase price of the plane ticket to an environmental charity. Such a donation would offset the carbon that was released into the atmosphere. A consumer can become carbon neutral by matching the amount of carbon emitted from all of the goods and services purchased with donations to such environmental charities.

There are lists collating the amount of carbon released for different industries and many companies calculate their own carbon emissions or impact on the environment. Some individual merchants, e.g., restaurants, have calculated their own carbon emissions. Some merchants advertise their carbon neutral status, which is achieved by counteracting any emissions through planting trees or other environmental activities. In the systems described herein, these emission amounts are compiled into offset factors, which can be used to calculate the donation needed to offset the carbon released into the atmosphere from the purchased goods or services. In some embodiments, the offset factor is a percentage that may be applied against the purchase price of a good or service. The offset factors for different industries and individual merchants can be compiled and stored in a database.

When a cardholder initiates a purchase at an originating merchant with a payment card, an authorization request is typically sent to an acquiring bank and then through a payment processing network to an issuer processor. The authorization request message includes transaction information including, but not limited to, a merchant ID, a merchant category, a transaction amount, and other data. In the example embodiment, an Environment Impact (“EI”) computing device is associated with or in communication with the issuing bank. In another embodiment, the EI computing device may be associated with or in communication with the payment processing network.

When a payment transaction is processed by the payment network, the EI computing device queries the database of offset factors to retrieve the offset factor associated with the merchant ID in the authorization request. The offset factor may be set by the originating merchant or may default to the offset factor associated with the originating merchant's industry. The offset factor may be a percentage of the purchase price that represents the amount of carbon, or other greenhouse gas, released into the atmosphere as a result of providing a service or product to the consumer. The EI computing device calculates an offset amount by applying the offset factor to the transaction amount to create an offset amount. In this embodiment, the offset amount is an amount of money that may be donated on behalf of the cardholder to an environmental charity to counteract the environmental impact of the cardholder's purchase. For example, the offset amount may be the cost to plant the trees required to remove the 0.7 metric tons of carbon from the atmosphere that were released by the cardholder's flight from New York to Los Angeles. The EI computing device invoices the cardholder for the purchase price of the product or service along with the offset amount, records the offset amount, and accrues the offset amount in an escrow account.

After receiving payment, the EI computing device electronically deposits the offset amount in the escrow account and removes the accrual. Periodically, the EI computing device causes the electronic deposits stored within the escrow account to be donated (i.e., transferred) to an environmental charity. For example, the environmental charity could work to reduce carbon (e.g., by planting trees) or to cut emissions of greenhouse gases (e.g., renewable energy projects such as solar power). Periodically, the issuer processor sends the cardholder a report of the offset amounts associated with that cardholder given to the environmental charity, which can be used for tax purposes. The environmental charity may be selected or pre-selected by the issuer processor or selected by the cardholder.

In another embodiment, a cardholder enrolls in a rewards program wherein the rewards (e.g., 1% of purchases) are applied to decreasing the environmental impact of the payment processing network and/or the issuer processor. In one embodiment, decreasing the environmental impact is done through upgrades such as making data centers of the payment network solar-powered or improving the energy efficiency of the data center buildings.

In a further embodiment, the offset amount may be reduced by the cardholder by a participation percentage, which would decrease the amount the issuer processor collects from the cardholder.

The methods and systems described herein may be implemented using computer programming or engineering techniques including computer software, firmware, hardware, or any combination or subset wherein a technical effect of the systems and processes described herein is achieved by performing at least one of the following steps: (a) providing an environmental impact computing device in communication with a payment processing network and a memory, where the memory may be a part of the payment processing network or it may be separate; (b) storing, in the memory, a plurality of offset factors associated with a plurality of merchants wherein each offset factor is associated with a specific merchant or with a merchant type; (c) receiving a first authorization request message for a payment transaction from an originating merchant for a cardholder including a transaction amount; (d) determining the offset factor associated with the originating merchant; (e) calculating, by the environmental impact computing device, an offset amount based on the transaction amount, the offset factor, and a participation percentage set by the cardholder; (f) recording the offset amount; (g) accruing the offset amount in an escrow account; (h) invoicing the cardholder for the offset amount; (i) receiving from the cardholder the offset amount; (j) electronically depositing the offset amount in the escrow account and removing the accrual from the escrow account; (k) transferring the electronic deposits of the escrow account to a charity as a donation made by the cardholder; and (l) transmitting a report to the cardholder of the offset amounts transmitted to a charity. In addition, the system described above could also include a rewards program that applies 1% of the total value of the cardholder's purchases to decreasing the environmental impact of the payment processing network and/or the issuer processor.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

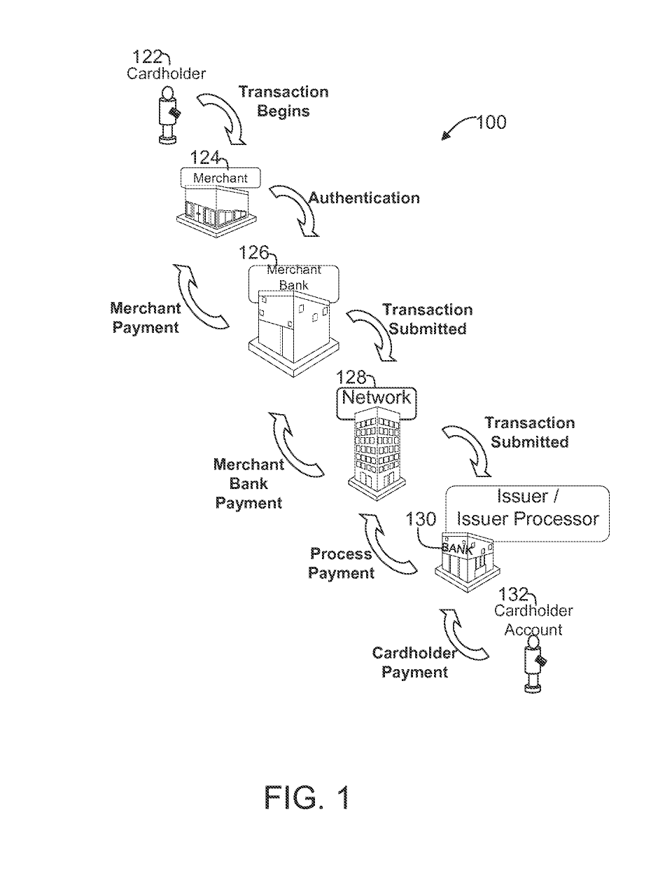

FIG. 1 is a schematic diagram illustrating an example multi-party payment card system 100 for enabling ordinary payment-by-card transactions in which merchants and card issuer processors do not necessarily have a one-to-one relationship. The present disclosure relates to payment card system 100, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 100, a financial institution such as an issuer issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer processor 130, to determine whether the cardholder's account 132 is in good standing and whether the purchase is covered by the cardholder's available credit line or account balance. Based on these determinations, the request for authorization will be declined (“denied”) or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer processor, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer processor 130. Settlement refers to the transfer of financial data or funds between the merchant's account, acquirer 126, and issuer processor 130 related to the transaction. Usually, transactions are captured and accumulated into a “batch,” which is settled as a group.

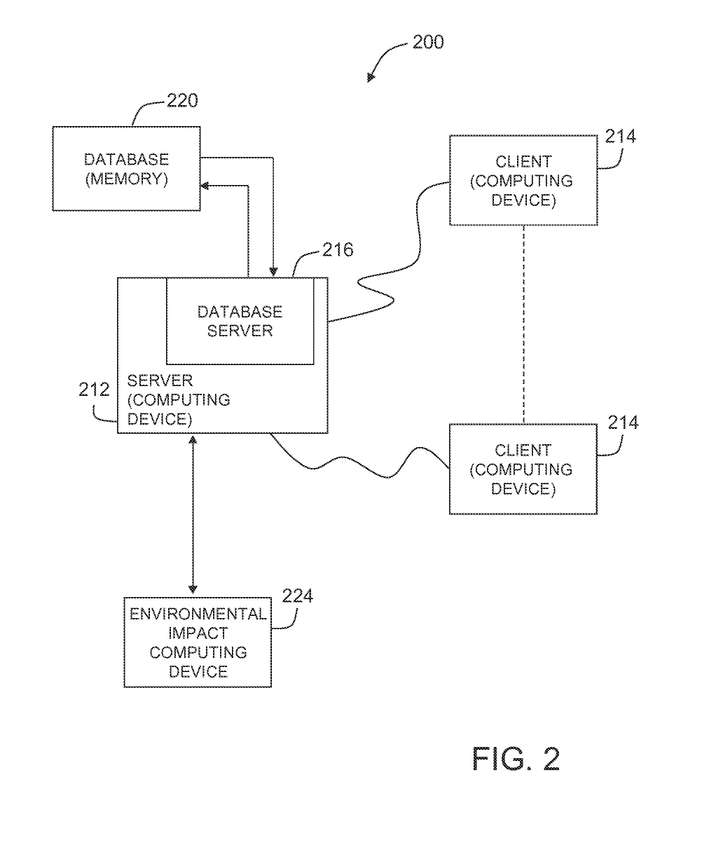

FIG. 2 is a simplified block diagram of an example environment impact system 200 configured to generate environmental impact offsets for cardholder purchases in accordance with one embodiment of the present disclosure. More specifically, system 200 includes a server system 212 communicatively coupled to a plurality of client systems 214, also known as client computing devices. Server system 212 and client systems 214 are configured for payment transactions initiated by cardholders using a payment card.

In some embodiments, server system 212 may be associated with a financial transaction interchange network, and may be referred to as an interchange computer system. Server system 212 may be used for processing transaction data and for registering cardholders and/or merchants into a plurality of programs offered by the interchange network, including, but not limited to, a rewards program. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 may include point-of-sale (POS) device associated with a merchant and used for processing payment transactions. POS devices could be, but are not limited to, machines that accept card swipes, online payment portals, or stored payment card numbers for recurring transactions.

An EI computing device 224 is communicatively coupled with the server system 212. The EI computing device 224 can access the server system 212 to store and access data and to communicate with the client systems 214 through the server system 212. In some embodiments, the EI computing device 224 is a part of the payment card system 100, shown in FIG. 1. In the example embodiment, the EI computing device 224 is associated with the issuer processor 130. In other embodiments, the EI computing device 224 may be in communication with the issuer processor 130. In further embodiments, the EI computing device 224 may be associated with or in communication with the payment card system payment network 128.

A database server 216 is communicatively coupled to a database 220 that stores data. In one embodiment, database 220 includes offset factors, merchant categories, and merchant IDs. In the example embodiment, database 220 is stored remotely from server system 212. In some embodiments, database 220 is decentralized. In the example embodiment, a person can access database 220 via client systems 214 by logging onto server system 212, as described herein.

In the example embodiment, client systems 214 are computers that include a web browser, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, or other web-based connectable equipment.

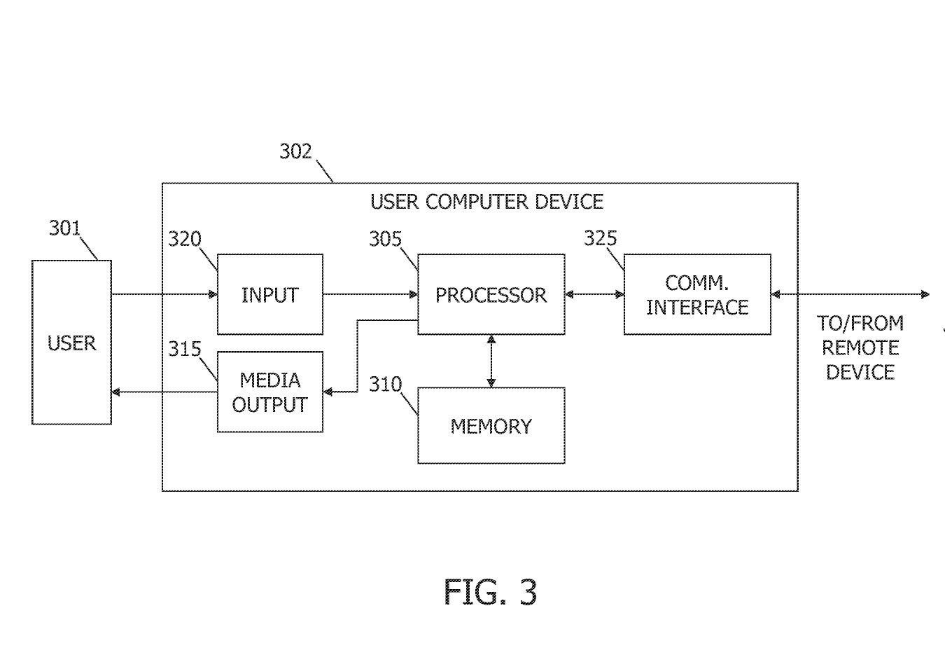

FIG. 3 illustrates an example configuration of a client system 214 shown in FIG. 2, in accordance with one embodiment of the present disclosure. Client system 214 may be associated with a merchant 124. User computer device 302 is operated by a user 301. User computer device 302 may include, but is not limited to, client systems 214 (shown in FIG. 1). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 1). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

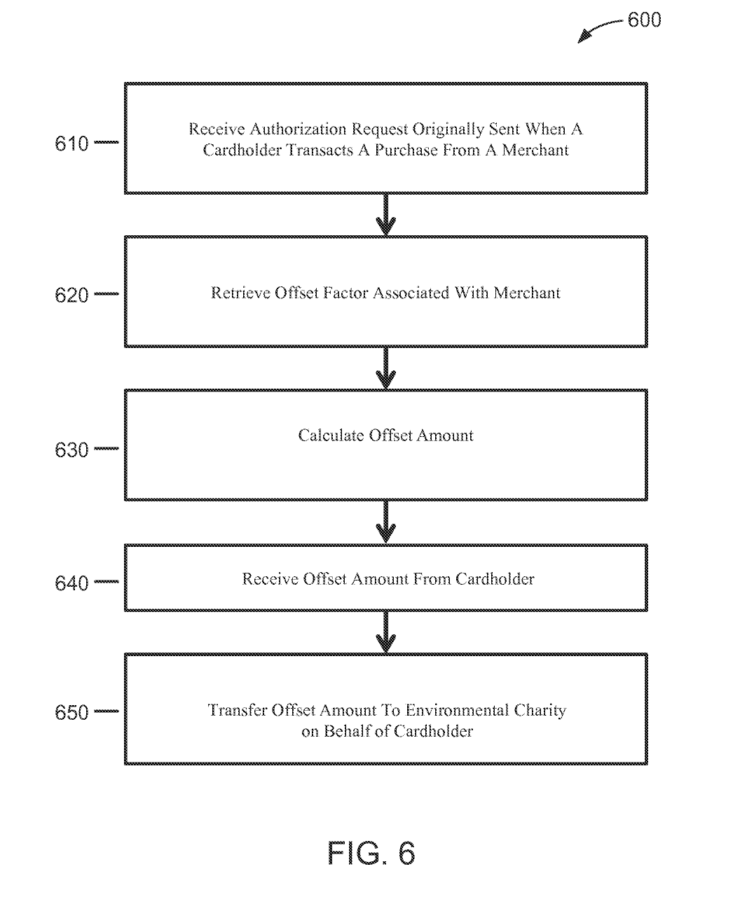

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 is programmed with the instruction such as illustrated in FIG. 6.

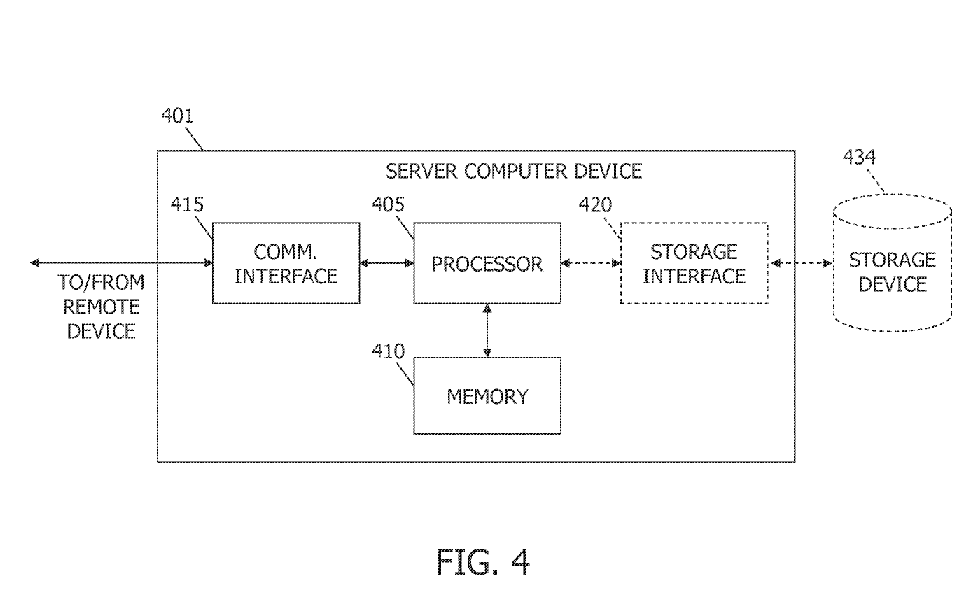

FIG. 4 illustrates an example configuration of the server system 212 shown in FIG. 2, in accordance with one embodiment of the present disclosure. Server computer device 401 may include, but is not limited to, database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as client systems 214, another server computer device 401, or EI computer device 224. For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

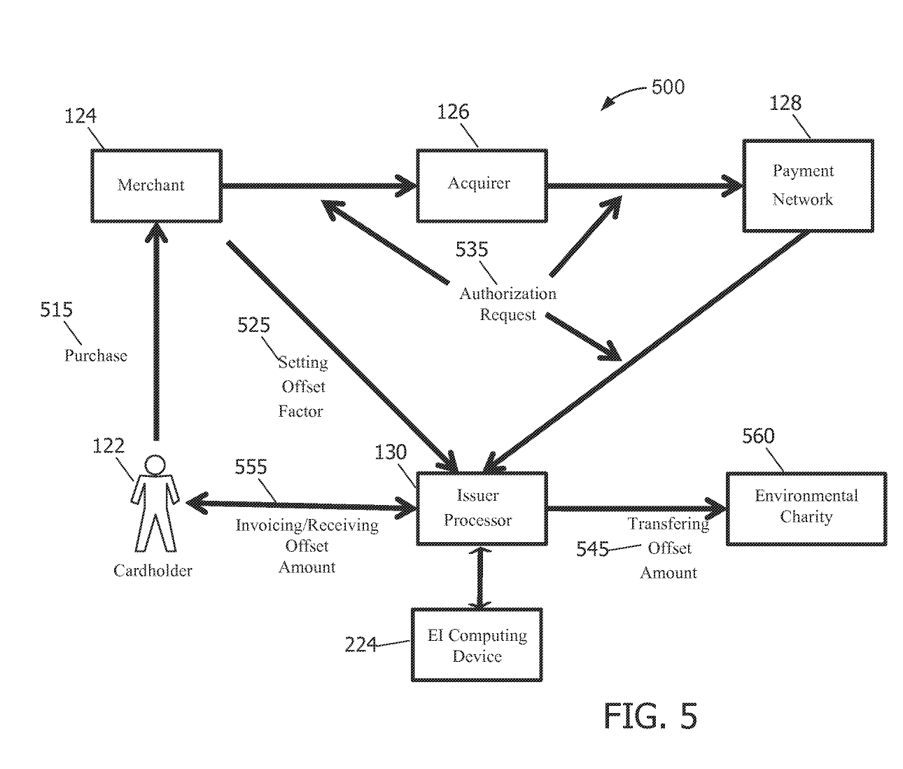

FIG. 5 is a schematic diagram 500 which illustrates an example of integrating a multi-party payment card system 100 with generating environmental impact offsets for cardholder purchases. In an example embodiment, when a cardholder 122 initiates a purchase 515 at an originating merchant 124 with a payment card, an authorization request 535 is sent to the acquirer 126 and then through the payment card system payment network 128 to the issuer processor 130, as shown in FIG. 1. The cardholder's purchase 515 may be initiated through many methods including, but not limited to, a card swipe, an online purchase, or a recurring charge. The authorization request 535 includes transaction information including a merchant ID, a transaction amount, and other data. In the example embodiment, the EI computing device 224 is associated with the issuer processor 130. In another embodiment, the EI computing device 224 may be associated with the payment card system payment network 128. In yet another embodiment, the EI computing device 224 may be separate from the multi-party payment card system 100.

The database 220 stores a plurality of offset factors associated with multiple merchants 124. Each offset factor may be connected to an individual merchant's merchant ID or to a merchant category (e.g., airline, restaurant, or lumber yard). The EI computing device 224 uses the merchant ID from the authorization request to query the database 220 to retrieve the offset factor associated with the originating merchant 124. When the EI computing device 224 sends a query to the database 220, the database 220 first compares the merchant ID to those merchant IDs stored in the database 220, which are associated with specific offset factors, to see if there is a specific offset factor associated with the originating merchant 124. If no merchant specific offset factor is found, then the database 220 returns the offset factor for the originating merchant's merchant category. In one embodiment, offset factor may be the percentage of the purchase price that represents the amount of carbon, or other greenhouse gas, released into the atmosphere. In the example embodiment, the EI computing device 224 multiplies the offset factor by the transaction amount to provide an offset amount. While the example embodiment uses multiplication, in other embodiments the operation may involve other steps, such as, but not limited to, a look-up table, a participation percentage, or a flat amount. The EI computing device 224 records the offset amount, accrues the offset amount in an escrow account, and invoices 555 the cardholder for the transaction amount and the offset amount.

After the offset amount is received 555 from the cardholder 122, the EI computing device 224 deposits the offset amount into the escrow account and removes the accrual. Periodically (i.e., once every month), the EI computing device 224 transfers 545 the contents of the escrow account to an environmental charity 560. The EI computing device 224 records the offset amounts that were donated on behalf of each cardholder 122. In the example embodiment, the EI computing device 224 may receive the offset amount from the cardholder 122 in an electronic transfer. For example, the environmental charity 560 could work to reduce carbon (e.g., by planting trees) or to cut emissions of greenhouse gases (e.g., renewable energy projects such as solar power). Periodically, the EI computing device 224 transmits to the cardholder 122 a report of the offset amounts associated with that cardholder 122 given to the environmental charity 560. The cardholder may use this report for tax purposes. The environmental charity 560 may be selected or preselected by the issuer processor 130 or selected by the cardholder 122.

In one embodiment, the issuer processor 130 sets the offset factors in the database 220 based on the various merchant categories. Additionally, one or more categories could be created specifically for merchants 124 that meet one or more environmental standards, such as for a merchant that is powered by renewable energy, e.g., solar energy. In a further embodiment, individual merchants 124 may set their own offset factor 525 by submitting their own offset factor to the issuer processor 130 for inclusion in the database. In yet another embodiment, the database 220 of offset factors could be maintained by the payment card system payment network 128.

In another embodiment, the cardholder 122 enrolls in a rewards program wherein the rewards (e.g., 1% of purchases) are applied to decreasing the environmental impact of the payment card system payment network 128 and/or the issuer processor 130. In one embodiment, decreasing the environmental impact is done through upgrades such as making data centers solar powered or improving the energy efficiency of the data center buildings.

In the example embodiment, the offset amount may be reduced by the cardholder 122 by a participation percentage, which would decrease the offset amount calculated by the EI computing device 224. For example, the cardholder 122 could set the participation percentage at 50%. In this case, the offset amounts calculated for that cardholder 122 are reduced by half. This may be a way for a cardholder to ramp up participation in the program by starting at a lower participation percentage and increasing it over time.

FIG. 6 is a flowchart illustrating the process 600 of generating environmental impact offsets for cardholder purchases, in accordance with one embodiment of the present disclosure.

Process 600 may be implemented by a computing device, for example, the EI computing device 224. Initially, the EI computing device 224 receives 610 the authorization request 535 that was sent when the cardholder 122 transacted a purchase with the originating merchant 124 (as shown in FIG. 5). The EI computing device 224 retrieves 620 the offset factor associated with the originating merchant 124. The EI computing device 224 uses the offset factor to calculate 630 the offset amount. Then the EI computing device 224 receives 640 the offset amount from the cardholder 122. Step 640 may be completed by the EI computing device 224 invoicing the cardholder 122 for the transaction amount and the offset amount. After the EI computing device 224 receives offset amount in the form of an electronic transfer from the cardholder 122, the EI computing device 224 deposits the offset amount in an escrow account. Finally, the EI computing device 224 electronically transfers 650 the offset amount to an environmental charity 560 on behalf of the cardholder 122.

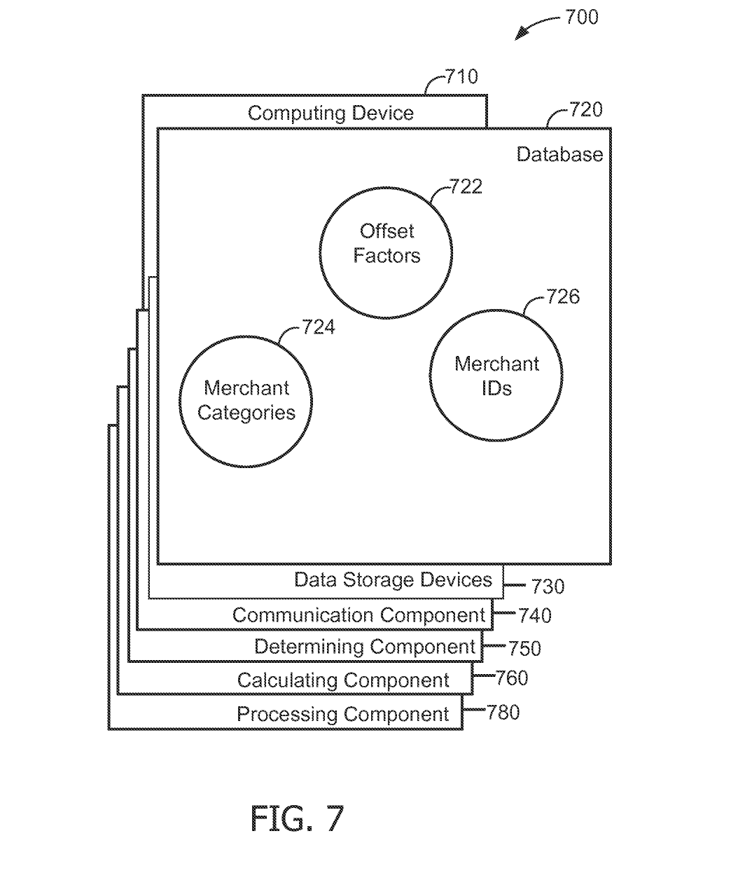

FIG. 7 is a diagram 700 of components of one or more example computing devices that may be used in the environmental impact system 200 shown in FIG. 2. In some embodiments, computing device 710 is similar to server system 212 (shown in FIG. 2); it may also be similar to EI computing device 224. Database 720 may be coupled with several separate components within computing device 710, which perform specific tasks.

In this embodiment, database 720 includes offset factors 722, merchant categories 724 and merchant IDs 726. In some embodiments, database 720 is similar to database 220 (shown in FIG. 2).

Computing device 710 includes the database 720, as well as data storage devices 730. Computing device 710 also includes a communication component 740 for receiving offset factors 722 from merchants and transaction amounts from the issuer processor 130, and for sending offset amounts to client systems 214 (shown in FIG. 2). Computing device 710 also includes a determining component 750 for determining the offset factor 722 associated with a merchant ID 726 or merchant category 724. A calculating component 760 is also included for calculating the offset amount based on the transaction amount and the offset factor 722. A processing component 780 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for generating environmental impact offsets for payment card transactions, said method implemented using a computing device in communication with a memory, said method comprising:
storing, in the memory, at least one of a plurality of offset factors associated with at least one of a plurality of merchants;
receiving a first authorization request message for a payment transaction originating from an originating merchant for a cardholder that includes a transaction amount;
determining the offset factor associated with the originating merchant;
calculating, by the computing device, an offset amount based on the transaction amount and the offset factor; and
outputting the offset amount.

2. The method in accordance with claim 1 further comprising receiving an electronic transfer from the cardholder for the offset amount, storing the offset amount in an account, electronically transferring the offset amount to a charitable organization on behalf of the cardholder, and providing a summary report to the cardholder.

3. The method in accordance with claim 1, wherein calculating an offset amount further comprises calculating the offset amount based on a participation percentage set by the cardholder.

4. The method in accordance with claim 1, wherein storing a plurality of offset factors further comprises receiving the offset factor from the originating merchant wherein the offset factor is configured to offset the environmental impact of a purchase from the merchant.

5. The method in accordance with claim 1, wherein storing a plurality of offset factors further comprises storing a plurality of offset factors for a plurality of merchant categories wherein each of the plurality of merchant categories contains a plurality of related merchants.

6. The method in accordance with claim 5 further comprising creating and storing one or more merchant categories each with an associated offset factor for merchants that meet one or more environmental standards.

7. The method in accordance with claim 1 further comprising applying a cardholder reward to energy efficiency projects of a payment processing network.

8. A computing device for generating environmental impact offsets for payment card transactions, said computing device comprising a processor communicatively coupled to a memory device, said computing device configured to:
store a plurality of offset factors associated with a plurality of merchants;
receive a first authorization request message for a payment transaction originating from an originating merchant for a cardholder that includes a transaction amount;
determine the offset factor associated with the originating merchant;
calculate an offset amount based on the transaction amount and the offset factor; and
output the offset amount.

9. The computing device of claim 8, wherein said computing device is further configured to receive an electronic transfer from the cardholder for the offset amount, store the offset amount in an account, electronically transfer the offset amount to a charitable organization on behalf of the cardholder, and provide a summary report to the cardholder.

10. The computing device of claim 8, wherein said computing device is further configured to calculate the offset amount based on a participation percentage set by the cardholder.

11. The computing device of claim 8, wherein said computing device is further configured to receive the offset factor from the originating merchant wherein the offset factor is configured to offset the environmental impact of a purchase from the merchant.

12. The computing device of claim 8, wherein said computing device is further configured to store a plurality of offset factors for a plurality of merchant categories wherein each of the plurality of merchant categories contains a plurality of related merchants.

13. The computing device of claim 12, wherein said computing device is further configured to create and store one or more merchant categories each with an associated offset factor for merchants that meet one or more environmental standards.

14. The computing device of claim 8 further configured, wherein said computing device is further configured to apply a cardholder reward to energy efficiency projects of a payment processing network.

15. A computer-readable storage medium having computer-executable instructions embodied thereon, wherein when executed by a computing device having at least one processor coupled to a memory device, the computer executable instructions cause the processor to:
store a plurality of offset factors associated with a plurality of merchants;
receive a first authorization request message for a payment transaction originating from an originating merchant for a cardholder that includes a transaction amount;
determine the offset factor associated with the originating merchant;
calculate an offset amount based on the transaction amount and the offset factor; and
output the offset amount.

16. The computer-readable storage medium of claim 15, wherein the computer-executable instructions further cause the processor to receive an electronic transfer from the cardholder for the offset amount, store the offset amount in an account, electronically transfer the offset amount to a charitable organization on behalf of the cardholder, and provide a summary report to the cardholder.

17. The computer-readable storage medium of claim 15, wherein the computer-executable instructions further cause the processor to calculate the offset amount based on a participation percentage set by the cardholder.

18. The computer-readable storage medium of claim 15, wherein the computer-executable instructions further cause the processor to receive the offset factor from the originating merchant wherein the offset factor is configured to offset the environmental impact of a purchase from the merchant.

19. The computer-readable storage medium of claim 15, wherein the computer-executable instructions further cause the processor to store a plurality of offset factors for a plurality of merchant categories wherein each of the plurality of merchant categories contains a plurality of related merchants.

20. The computer-readable storage medium of claim 15, wherein the computer-executable instructions further cause the processor to apply a cardholder reward to energy efficiency projects of a payment processing network.
